(19) United States
(12) Patent Application Publication
(10) Pub. No.: US 2006/0188414 A1
(43) Pub. Date: Aug. 24, 2006

(54) Polymerization reactant injection system

(76) Inventors: Gerald B. Eaton, Houston, TX (US); Alan K. Ebert, Houston, TX (US)

Correspondence Address: BRACEWELL & GIULIANI LLP, P.O. BOX 61389, HOUSTON, TX, 77208-1389, US

(21) Appl. No.: 11/406,041

(22) Filed: Apr. 18, 2006

Related U.S. Application Data
(62) Division of application No. 10/242,893, filed on Sep. 12, 2002.

(51) Int. Cl. B01J 19/00

(52) U.S. Cl. 422/131

(57) ABSTRACT

A polymerization reactant injection system having a monomer conduit, a co-catalyst conduit, and a catalyst conduit, in fluid communication with each other such that a polymerization reactant mixture may be formed without mechanical mixers or agitators. The polymerization reactant injection systems of the present invention permit large amounts of polymerization reactant mixtures to be formed without the increased costs associated with additional mechanical equipment. Methods for forming polymerization reactant mixtures are also disclosed.

### BACKGROUND OF THE INVENTION

1. Field of the Invention

This invention relates to injection systems for transporting polymerization reactants from their source tanks to form a polymerization reactant mixture prior to injection of the polymerization reactant mixture into a polymerization reactor, and in particular, polymerization reactant injection systems for transporting monomer, catalyst, and co-catalysts from their respective source tanks to form a polymerization reactant mixture prior to the polymerization reactant mixture being injected into one or more bulk polymerization reactors.

2. Description of Related Art

Formation of polymers from various monomers is a well-known art. As is also well known in the art, the polymerization reactor system in which the polymers are formed from the monomers have certain inherent limitations to efficiently form the polymers. A major inherent limitation is the fact that monomer, catalyst, and co-catalyst (referred to herein individually and collectively as “polymerization reactants”) should be throughly combined to form a polymerization reactant mixture for polymerization in the polymerization reactors. As used herein, the term “polymerization reactant mixture” refers to a combination of one or more polymerization reactants that is capable of undergoing polymerization. As those skilled in the art will recognize, the minimum polymerization reactants necessary for polymerization to occur are monomer and catalyst.

In the event that the polymerization reactants are not throughly combined to form the polymerization reactant mixture, the polymerization reaction will likely not be optimized resulting in areas of no polymerization, and areas of high concentrations of un-reacted monomer, catalyst, or co-catalyst. To overcome this problem, prior polymerization reactors include a tank having a mechanical agitator or mixer which is used to mix the monomer, the catalyst, and the co-catalyst prior to injection into the polymerization reactors. Alternatively, mechanical mixers or other mechanical agitating devices may be placed in connection with, or within, the polymerization reactor to mix the polymerization reactants.

Both of these prior attempts, however, have various shortcomings. For example, the use of a separate “mixing” tank or separate agitators or mixers in the polymerization reactor is costly. In addition to the cost of a separate tank and mixing device, the tank and mixing devices must be cleaned after each use to remove any polymer that formed and attached to the side of the tank or the mixing devices during mixing. Further, routine maintenance of the tanks and mixing devices and agitators is required. Therefore, disposal and cleaning costs, as well as maintenance costs, are also increased.

Accordingly, prior to the development of the present invention, there has been no polymerization reactant injection system or process for forming a polymerization reactant mixture, which: effectively combines the polymerization reactants without the necessity of a mixing tank or mechanical mixers or other mechanical agitating devices; decreases the cost of carrying out the polymerization reaction because the increased cost of clean-up and maintenance of mixing tanks or mechanical mixers and agitators is not incurred; and decreases the cost of carrying out the polymerization reaction because costly mixing tanks or mechanical mixers and agitators are not required. Therefore, the art has sought a polymerization reactant injection system and a process for forming a polymerization reactant mixture, which: effectively combines the polymerization reactants without the necessity of a mixing tank or mechanical mixers or other mechanical agitating devices; decreases the cost of carrying out the polymerization reaction because the increased cost of clean-up and maintenance of mixing tanks or mechanical mixers and agitators is not incurred; and decreases the cost of carrying out the polymerization reaction because costly mixing tanks or mechanical mixers and agitators are not required.

### SUMMARY OF INVENTION

In accordance with the invention, the foregoing advantages have been achieved through the present polymerization reactant injection system comprising: at least one monomer conduit for transporting at least one monomer at a first fluid parameter; at least one catalyst conduit for transporting at least one catalyst at a second fluid parameter, the at least one catalyst conduit being in fluid communication with the at least one monomer conduit; and at least one polymerization reactant mixture conduit, wherein the at least one monomer is combined with the at least one catalyst to form a polymerization reactant mixture within the at least one polymerization reactant mixture conduit; wherein the first fluid parameter and the second fluid parameter create a fluid parameter differential.

The term “fluid parameter” as used herein means a characteristic of the polymerization reactant or polymerization reactant mixture as it is being transported through, and from, their respective conduits. Fluid parameters include, but are not limited to, the pressure, the velocity, and the temperature of the polymerization reactants and the polymerization reactant mixture.

The term “fluid parameter differential” as used herein means the difference between identical fluid parameters of at least two of the polymerization reactants or at least one of the polymerization reactants and the polymerization reactant mixture. Due to the fluid parameter differential, one polymerization reactant is injected into, or combined with, at least one other polymerization reactant to ultimately form the polymerization reactant mixture.

The fluid parameter “velocity”of the polymerization reactants or the polymerization reactant mixture as used herein means the rate of flow of the polymerization reactants, or the polymerization reactant mixture, past a predetermined point(s) over a set period of time, e.g., gallons or pounds per minute past a valve or conduit junction or a distance along the conduit such as in inches per second. In some instances, outside factors may dictate the minimum velocity of one or more of the polymerization reactants or the polymerization reactant mixture. For example, the type of catalyst or catalyst slurry may require a high velocity to prevent the catalyst particles from accumulating on the bottom of the catalyst conduit. Those skilled in the art are able to identify desired velocities of the polymerization reactants and the polymerization reactant mixture through the polymerization reactant injection systems of the invention based upon the polymerization reactants selected, temperature curves for the polymerization reactants, the size and number of the polymerization reactors, and the cooling capacity of the polymerization reactors, without undue experimentation.

Therefore, the “velocity differential” is the difference between the velocities of at least two of the polymerization reactants or at least one of the polymerization reactants and the polymerization reactant mixture. Due to the velocity differential, one polymerization reactant is injected into, or combined with, at least one other polymerization reactant to ultimately form the polymerization reactant mixture.

The velocity of the polymerization reactants, and thus the velocity differential, may be formed by the arrangement of the conduits used to transport the polymerization reactants, e.g., one conduit is parallel to the force of gravity and a second conduit is disposed at a 45 degree angle such that the polymerization reactant in the first conduit has a higher velocity than the polymerization reactant in the second conduit. In this specific embodiment, the pressure of the polymerization reactants and the polymerization reactant mixture may be at the same pressure.

The fluid parameter “pressure” of the polymerization reactants or the polymerization reactant mixture as used herein means the pressure (e.g., in pounds per inch or psi) at which the polymerization reactants, or the polymerization reactant mixture, is transported through and out of its respective conduit. In embodiments in which the fluid parameter differential is a pressure differential, the pressure at which one polymerization reactant, or the polymerization reactant mixture, is transported through and released from its conduit is different from the pressure at which a second polymerization reactant, or the polymerization reactant mixture, is transported through its conduit, thereby forming the pressure differential.

Therefore, the “pressure differential” is the difference between the pressures of at least two of the polymerization reactants or at least one of the polymerization reactants and the polymerization reactant mixture. As discussed below, the pressures are preferably measured at the point where each polymerization reactant is released from its conduit to be combined with another polymerization reactant and where the polymerization reactant mixture is released from the polymerization reactant injection system into a polymerization reactor. Due to the pressure differential, one polymerization reactant is injected into, or combined with, at least one other polymerization reactant to ultimately form the polymerization reactant mixture.

The pressure differential may be formed by applying different pressures to the source tanks of the polymerization reactants, applying a vacuum to the conduits of the polymerization reactants and polymerization reactant mixture, utilizing pumps, or by utilizing conduits for the delivery of the polymerization reactants to the polymerization reactant injection system and the polymerization reactant mixture to the polymerization reactors having varying inner diameters, referred to herein as “diameter,” which determines the cross-sectional area of the conduit through which the polymerization reactants, or polymerization reactant mixture, may be transported. For example, the at least one monomer is transported through the monomer conduit at a first pressure, the catalyst is transported through the catalyst conduit at a second pressure, and the first pressure is not equal to the second pressure.

It is to be understood that the monomer conduit, co-catalyst conduit, catalyst conduit, polymerization reactant mixture conduit and the reactor conduit may have any cross-sectional shape, e.g., circular, oval, square, desired or necessary to facilitate the flow of the polymerization reactants through the polymerization reactant injection system at a fluid parameter differential. Simple and known mathematic equations are used to calculate the cross-sectional area of the conduits based upon the dimensions, e.g., diameter, length, width, or arc-length, of the cross-sectional shape. As discussed, herein, the conduits are circularly-shaped having a diameter for calculating the cross-sectional area. However, in embodiments in which the conduits are not circularly-shaped, a person of ordinary skill in the art can easily calculate the cross-sectional area of the conduit to determine the size of the conduit desired or necessary to facilitate creation of the fluid parameter differential.

Alternatively, the velocity differential and pressure differential may be created using pumps, vacuums, or any other device or method known to persons of ordinary skill in the art. Additionally, the velocity differential and the pressure differential desired, or necessary to form the polymerization reactant mixture, may be easily determined by operators of the polymerization reactant injection system. However, the pressure of the polymerization reactant being injected into the other polymerization reactants must be greater than the pressure of those other polymerization reactants. For example, in the embodiment in which catalyst is being injected into monomer, the pressure of the catalyst must be greater than the pressure of the monomer. Alternatively, if the monomer is being injected into the catalyst, the pressure of the monomer must be greater than the velocity of the catalyst. Moreover, the pressure of the polymerization reactant mixture must be less than the pressure of the polymerization reactant being injected to form the polymerization reactant mixture. Otherwise, the polymerization reactant mixture would be prone to back-flow into the conduit of the polymerization reactant being injected.

A further feature of the polymerization reactant injection system is that the polymerization reactant injection system may further comprise at least one co-catalyst conduit for transporting at least one co-catalyst, the at least one co-catalyst conduit being in fluid communication with the at least one monomer conduit, wherein the at least one monomer is mixed with the at least one co-catalyst to form a monomer/co-catalyst mixture. Another feature of the polymerization reactant injection system is that the at least one monomer conduit and the at least one co-catalyst conduit may intersect each other at a first conduit junction, the first conduit junction being in fluid communication with the polymerization reactant mixture conduit. An additional feature of the polymerization reactant injection system is that a monomer/co-catalyst mixture conduit may be in fluid communication with the first conduit junction and the polymerization reactant mixture conduit. Still another feature of the polymerization reactant injection system is that a second conduit junction may be in fluid communication with the monomer/co-catalyst mixture conduit, the catalyst conduit, and the polymerization reactant mixture conduit. A further feature of the polymerization reactant injection system is that the polymerization reactant mixture conduit may include a loop. Another feature of the polymerization reactant injection system is that the polymerization reactant injection system further includes at least one reactor conduit. An additional feature of the polymerization reactant injection system is that the polymerization reactant mixture conduit may include a third conduit junction, whereby the polymerization reactant mixture is transported to at least one polymerization reactor through at least one reactor conduit, the at least one reactor conduit being in fluid communication with the third conduit junction. Still another feature of the polymerization reactant injection system is that a portion of the at least one catalyst conduit may be disposed within the at least one monomer conduit. Yet another feature of the polymerization reactant injection system is that a portion of the at least one monomer conduit may be disposed within the at least one catalyst conduit. A further feature of the polymerization reactant injection system is that the catalyst conduit may have a first diameter and the polymerization reactant mixture conduit may have a second diameter, the first diameter being smaller than the second diameter. Another feature of the polymerization reactant injection system is that a portion of the catalyst conduit may be disposed within the polymerization reactant mixture conduit. Still another feature of the polymerization reactant injection system is that the catalyst conduit may have a first diameter and the polymerization reactant mixture conduit may have a second diameter, the first diameter being larger than the second diameter. A further feature of the polymerization reactant injection system is that a portion of the polymerization reactant mixture conduit may be disposed within the catalyst conduit. Another feature of the polymerization reactant injection system is that the first fluid parameter may be a first pressure, the second fluid parameter may be a second pressure, and the fluid parameter differential may be a pressure differential. Still another feature of the polymerization reactant injection system is that the first fluid parameter may be a first velocity, the second fluid parameter may be a second velocity, and the fluid parameter differential may be a velocity differential. An additional feature of the polymerization reactant injection system is that the polymerization reactant mixture conduit may be formed by the at least one monomer conduit and a portion of the at least one catalyst conduit may be disposed within the at least one monomer conduit. Still another feature of the polymerization reactant injection system is that the polymerization reactant mixture conduit may be formed by the at least one monomer conduit and a portion of the at least one monomer conduit may be disposed within the at least one catalyst conduit. A further feature of the polymerization reactant injection system is that the at least one monomer is transported at a first pressure, the at least one catalyst is transported at a second pressure, and the first pressure is not equal to the second pressure. Another feature of the polymerization reactant injection system is that the first pressure is less than the second pressure. An additional feature of the polymerization reactant injection system is that the first pressure is greater than the second pressure.

In accordance with the invention, the foregoing advantages have also been achieved through the present polymerization reactant injection system comprising: a monomer conduit for transporting at least one monomer at a first fluid parameter in fluid communication with a catalyst conduit for transporting at least one catalyst at a second fluid parameter, wherein the at least one catalyst is combined with the at least one monomer to form a polymerization reactant mixture, and wherein the first fluid parameter and the second fluid parameter form a fluid parameter differential.

A further feature of the polymerization reactant injection system is that the first fluid parameter may be greater than the second fluid parameter. Another feature of the polymerization reactant injection system is that the first fluid parameter may be a first pressure, the second fluid parameter may be a second pressure, and the fluid parameter differential may be a pressure differential. An additional feature of the polymerization reactant injection system is that the first fluid parameter may be a first velocity, the second fluid parameter may be a second velocity, and the fluid parameter differential may be a velocity differential. Still another feature of the polymerization reactant injection system is that the first fluid parameter may be less than the second fluid parameter. Still another feature of the polymerization reactant injection system is that the first fluid parameter may be a first pressure, the second fluid parameter may be a second pressure, and the fluid parameter differential may be a pressure differential A further feature of the polymerization reactant injection system is that the first fluid parameter may be a first velocity, the second fluid parameter may be a second velocity, and the fluid parameter differential may be a velocity differential.

In accordance with the invention, the foregoing advantages have also been achieved through the present method of forming a polymerization reactant mixture comprising the step of: combining at least one catalyst at a first fluid parameter with at least one monomer at a second fluid parameter, wherein the first fluid parameter and the second fluid parameter form a fluid parameter differential.

A further feature of the method of forming a polymerization reactant mixture is that at least one co-catalyst may be combined with the at least one monomer to form a monomer/co-catalyst mixture prior to combination with the at least one catalyst. Another feature of the method of forming a polymerization reactant mixture is that the first fluid parameter may be greater than the second fluid parameter. An additional feature of the method of forming a polymerization reactant mixture is that the first fluid parameter may be a first pressure, the second fluid parameter may be a second pressure, and the fluid parameter differential may be a pressure differential. Still another feature of the method of forming a polymerization reactant mixture is that the first fluid parameter may be a first velocity, the second fluid parameter may be a second velocity, and the fluid parameter differential may be a velocity differential. A further feature of the method of forming a polymerization reactant mixture is that the first fluid parameter may be less than the second fluid parameter. Another feature of the method of forming a polymerization reactant mixture is that the first fluid parameter may be a first pressure, the second fluid parameter may be a second pressure, and the fluid parameter differential may be a pressure differential. An additional feature of the method of forming a polymerization reactant mixture is that the first fluid parameter may be a first velocity, the second fluid parameter may be a second velocity, and the fluid parameter differential may be a velocity differential.

The polymerization reactor and process for forming a polymerization reactant mixture have the advantages of: effectively combining the polymerization reactants without the necessity of a mixing tank or mechanical mixers or other mechanical agitating devices; decreasing the cost of carrying out the polymerization reaction because the increased cost of clean-up and maintenance of mixing tanks or mechanical mixers and agitators is not incurred; and decreasing the cost of carrying out the polymerization reaction because costly mixing tanks or mechanical mixers and agitators are not required.

### BRIEF DESCRIPTION OF DRAWINGS

FIG. 1 is a schematic view of one specific embodiment of the polymerization reactant injection system of the present invention.

FIG. 2 a schematic view of a second specific embodiment of the polymerization reactant injection system of the present invention.

FIG. 3 is a detailed side view of a conduit junction for the combination of at least one monomer with at least one catalyst in another specific embodiment of the polymerization reactant injection system of the present invention.

FIG. 4 is a detailed view of the intersection of a monomer conduit and a catalyst conduit in another specific embodiment of the polymerization reactant injection system of the present invention.

FIG. 5a is a side view of a sample port in the closed position of one specific embodiment of the polymerization reactant injection system of the present invention.

FIG. 5b is a side view of the sample port shown in FIG. 5a in its opened position.

FIG. 6 is a schematic view of another specific embodiment of the polymerization reactant injection system of the present invention.

While the invention will be described in connection with the preferred embodiment, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF THE INVENTION

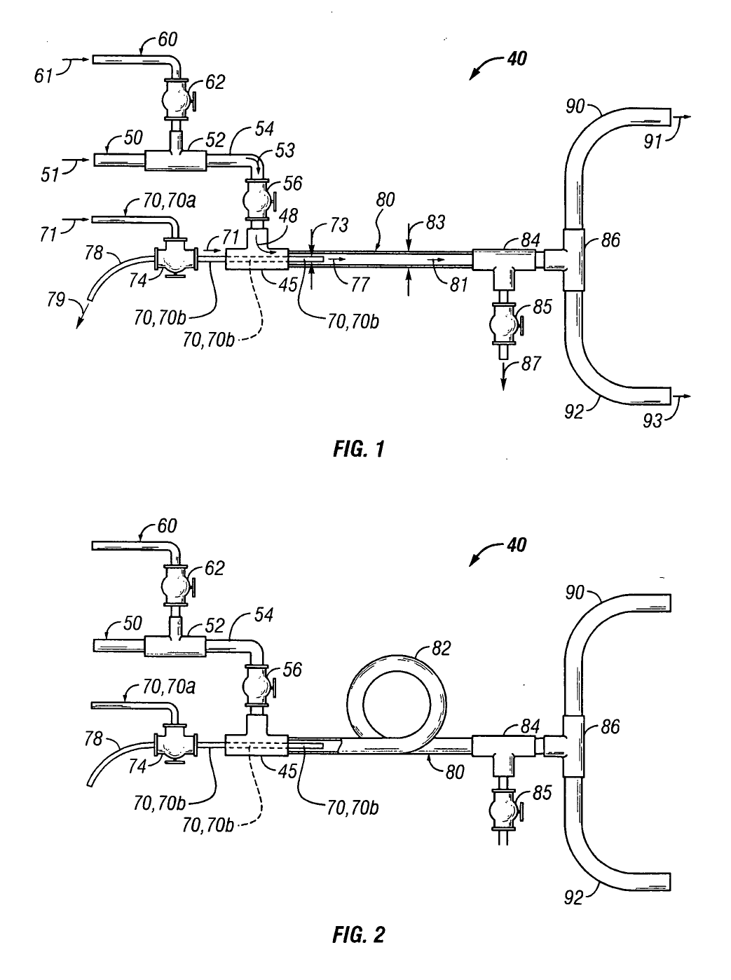

Broadly, the polymerization reactant injection system of the present invention includes a monomer conduit and a catalyst conduit. As shown in FIGS. 1-2, in one specific embodiment of the present invention, the polymerization reactant injection system includes a monomer conduit, a catalyst conduit, and a co-catalyst conduit. Referring now to FIGS. 1-2, polymerization reactant injection system 40 includes monomer conduit 50 in fluid communication with at least one monomer source tank (not shown) for transporting monomer from the at least one monomer source tank through polymerization reactant injection system 40 in the direction of arrow 51; co-catalyst conduit 60 in fluid communication with at least one co-catalyst source tank (not shown) for transporting co-catalyst from the at least one co-catalyst source tank through polymerization reactant injection system 40 in the direction of arrow 61; and catalyst conduit 70 in fluid communication with at least one catalyst source tank (not shown) for transporting catalyst from the at least one catalyst source tank through polymerization reactant injection system 40 in the direction of arrow 71. It is to be understood that the catalyst source tank may include liquid catalyst, or granular catalyst combined with a hydrocarbon solvent, e.g., hexane or heptane, to form a catalyst slurry. Additionally, it is to be understood that any monomer, or monomers, desired to be polymerized may be passed through monomer conduit 50. In a preferred embodiment, alpha olefin monomer transported through polymerization reactant injection system 40 to form drag reducing agents. In this preferred embodiment, the polymerization reactants and methods of forming drag reducing agents disclosed in U.S. Pat. Nos. 6,015,779, 6,162,773, 6,242,395, which are hereby incorporated by reference, are used and carried out using polymerization reactant injection system.

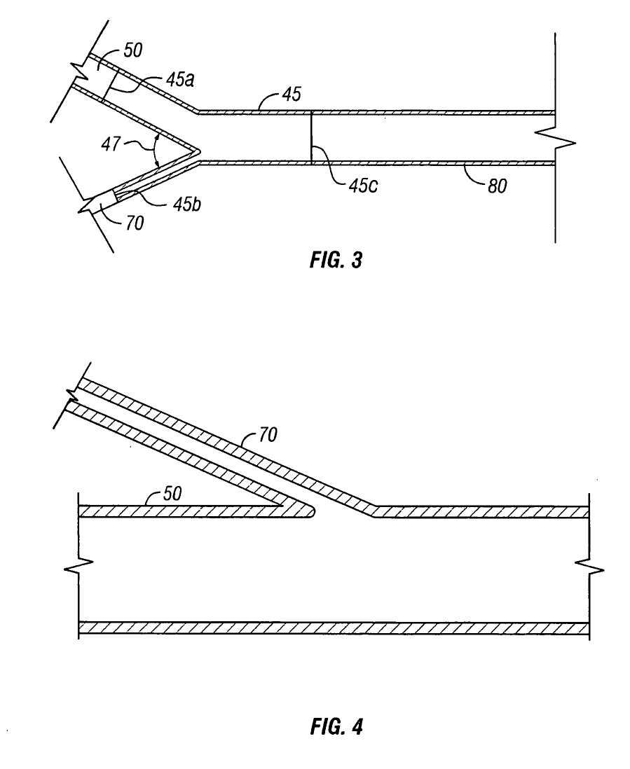

One or more monomers being transported through monomer conduit 50 are preferably combined with co-catalyst being transported through co-catalyst conduit 60 to form a monomer/co-catalyst mixture. To facilitate the formation of the monomer/co-catalyst mixture, preferably, conduit junction 52, e.g., a “T” junction (as shown in FIGS. 1-2), a “Y” junction (as shown in FIG. 3 with respect to conduit junction 45), or any other junction for connecting conduits and tubulars having any number of angles, e.g., 47 (FIG. 3) or number of connecting points, e.g., 45a, 45b, 45c (FIG. 3), is disposed at the intersection of monomer conduit 50 and co-catalyst conduit 60.

Alternatively, monomer conduit 50 and co-catalyst conduit 60 may be formed integral with each other, thereby permitting the formation of the monomer/co-catalyst mixture without a conduit junction in a manner similar to the combination of monomer and catalyst to form the polymerization reactance mixture as discussed below with respect to FIG. 4.

In a preferred embodiment, valve 62 is disposed along co-catalyst conduit 60 to regulate the flow of co-catalyst through co-catalyst conduit 60 from the at least one co-catalyst source tank to conduit junction 52. In one specific embodiment, valve 62 provides on-off control.

After the monomer/co-catalyst mixture is formed at conduit junction 52, the monomer/co-catalyst mixture is transported through monomer/co-catalyst mixture conduit 54 in the direction of arrow 53 to conduit junction 45. Valve 56 is preferably disposed along monomer/co-catalyst mixture conduit 54 between conduit junction 52 and conduit junction 45 to regulate the flow of the monomer/co-catalyst mixture through monomer/co-catalyst mixture conduit 54 to conduit junction 45. In one specific embodiment, valve 56 provides on-off control.

Catalyst (not shown) is injected into the monomer/co-catalyst mixture within conduit junction 45 (FIG. 3) or, preferably, at a point just past conduit junction 45 (FIGS. 1-2) to form the polymerization reactant mixture prior to injecting the polymerization reactant mixture into the polymerization reactor. In accomplishing the formation of the polymerization reactant mixture in embodiment shown in FIGS. 1-2, a portion of catalyst conduit 70 passes through conduit junction 45, and extends into, or is disposed within (in a manner similar to a cannula), polymerization reactant mixture conduit 80. In one specific embodiment, catalyst conduit 70 and polymerization reactant mixture conduit 80 are concentric. Although, it is to be understood that catalyst conduit 70 may not be disposed within polymerization reactant mixture conduit 80, or may not be disposed concentric with polymerization reactant mixture conduit 80, provided that catalyst is sufficiently dispersed throughout the other polymerization reactants to form the polymerization reactant mixture. For example, catalyst may be injected into the monomer at the inner wall of the monomer conduit (as shown in FIG. 4), provided that catalyst is being injected at a velocity, sufficient to disperse, or blend, the catalyst throughout the diameter of the monomer conduit. Further, inner diameter of 45 at connection point 45a, i.e., the connection point for monomer conduit 50 (FIG. 3), or monomer/co-catalyst conduit 54 (FIGS. 1-2), may be larger than the diameter of monomer conduit 50, or monomer/co-catalyst conduit 54, thereby facilitating a reduction in the pressure, and thus velocity, of the monomer, or monomer/co-catalyst mixture, through conduit junction 45. Therefore, the probability of unwanted back-flow of monomer, monomer/co-catalyst mixture, or polymerization reactant mixture, into catalyst conduit 70 is reduced.

While the distance catalyst conduit 70 extends into polymerization reactant mixture conduit 80 is not believed to be a controlling factor in formation of the polymerization reactant mixture in the embodiments in which catalyst conduit is disposed within polymerization reactant mixture conduit, preferably, catalyst conduit 70 extends approximately 0.5 inches to 8 inches into polymerization reactant mixture conduit 80, thereby facilitating the dispersion of catalyst throughout the monomer/co-catalyst mixture.

Catalyst enters into polymerization reactant mixture conduit 80 from catalyst conduit 70 in the direction of arrow 77. Monomer/co-catalyst mixture enters into polymerization reactant mixture conduit 80 through second conduit junction 45 in the direction of arrow 48. As shown in FIGS. 1-2 the diameter of catalyst conduit 70 may change after valve 74. In so doing, catalyst conduit 70a includes a diameter greater than catalyst conduit 70b, thereby increasing the pressure, and thus velocity, of catalyst through catalyst conduit 70b. Accordingly, the pressure differential between the catalyst and the monomer/co-catalyst mixture is increased.

To facilitate the combination of the catalyst with the monomer/co-catalyst mixture, catalyst conduit 70 includes diameter 73 which is preferably smaller than diameter 83 of polymerization reactant mixture conduit 80. The differences in diameter 73 and diameter 83, assisting the formation of the pressure differential whereby the pressure in catalyst conduit 70 is greater than the pressure in polymerization reactant mixture conduit 80.

Alternatively, in some specific embodiments, diameter 73 may be larger than diameter 83 to assist in creating the pressure differential such that the pressure in catalyst conduit 70 is less than the pressure in polymerization reactant mixture conduit 80. The pressure differential between catalyst conduit 70 and polymerization reactant mixture conduit 80 facilitates dispersion of catalyst through the monomer/co-catalyst mixture to form the polymerization reactant mixture in polymerization reactant mixture conduit 80.

Further, at no point beyond conduit junction 45 is diameter 83 of polymerization reactant mixture conduit 80 significantly altered, thereby reducing the possibility of back-flow into catalyst conduit 70. In other words, diameter 83 is constant. Alternatively, diameter 83 may be increased at some point beyond conduit junction 45, thereby reducing the possibility of back-flow into catalyst conduit 70.

Moreover, in embodiments in which polymerization reactant mixture conduit includes one or more reactor conduits, e.g., 90, 92 discussed in greater detail below, the sum total of the cross-sectional areas of the one or more reactor conduits is equal to, or greater than, the cross-sectional area of polymerization reactant mixture conduit 80.

In a preferred embodiment, catalyst conduit 70 includes three-way valve 74 disposed before conduit junction 45. Accordingly, the flow of catalyst from the catalyst source tank through catalyst conduit 70 and into conduit junction 45 may be regulated, diverted, or re-directed and allowed to re-circulate back to the catalyst source tank, or transported to a waste tank, through catalyst bypass conduit 78 in direction of arrow 79.

Polymerization reactant mixture is transported through polymerization reactant mixture conduit 80 to the polymerization reactor (not shown) in the direction of arrow 81. Preferably, polymerization reactant mixture conduit 80 is clear, thereby permitting the polymerization reactant mixture to be observed while being formed. Further, polymerization reactant mixture conduit 80 may be straight (FIG. 1) or include loop 82 (FIG. 2), thereby allowing the length of polymerization reactant mixture conduit 80 to be increased while maintaining the compact size of polymerization reactant injection system 40. Preferably, polymerization reactant mixture conduit 80 includes a loop (FIG. 2) to further facilitate observation of the polymerization reactant mixture as it is being formed, and to reduce the overall size of polymerization reactant injection system 40.

While it is to be understood that polymerization reactant mixture conduit 80 may transport the polymerization reactant mixture directly to a polymerization reactor, i.e., polymerization reactant injection system 40 includes one polymerization reactant mixture conduit 80 which also functions as a reactor conduit carrying the polymerization reactant mixture directly to the polymerization reactor, as shown in FIGS. 1-2, conduit junction 84 and conduit junction 86 may be disposed along polymerization reactant mixture conduit 80. Conduit junction 84, in conjunction with valve 85, permits polymerization reactant mixture to be removed from polymerization reactant injection system 40 in the direction of arrow 87 for sampling and other quality control tests.

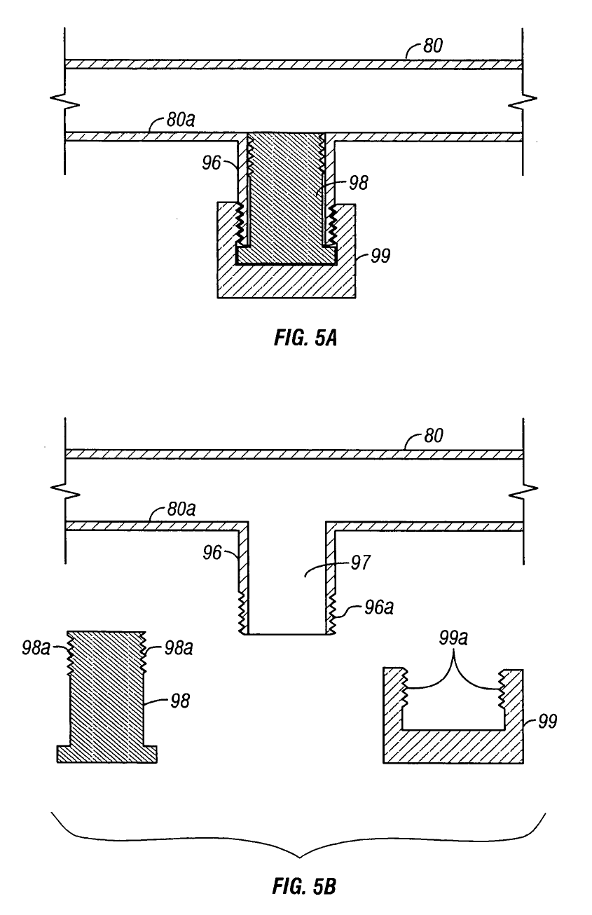

As illustrated in FIGS. 5a and 5b, junction conduit 84, or in one specific embodiment, polymerization reactant mixture conduit 80, may include sample port 96 having port cavity 97, plug 98, and cap 99. The shape and size of plug 98 corresponds to the shape and size of port cavity 97 providing as little tolerance as possible with port cavity 98 to prevent accumulation of the polymerization reactant mixture between sample port 96 and plug 98. Therefore, plug 98 is shaped and sized such that it sits flush with the inner wall 80a of polymerization reactant mixture conduit 80. Additionally, plug 98 preferably includes grooves and ridges 98a to assist in cleaning port cavity 97 each time plug 98 is removed and replaced.

Sample port 96 preferably includes threads 96a for mating with reciprocal threads 99a located on cap 99. Therefore, cap 99 may provide an air-tight closure to prevent contamination of the polymerization reactant mixture. In a preferred embodiment, sample port 96, plug 98, and cap 99 are formed from metal, e.g., aluminum or steel. Sample port 96 eliminates most, if not all, “dead zones,” e.g., areas where polymerization reactant mixture can settle and accumulate, thereby blocking the flow of the polymerization reactant mixture through polymerization reactant injection system 40.

Conduit junction 86 permits polymerization reactant mixture to be split into multiple reactor conduits 90, 92 for delivery of polymerization reactant mixture to multiple polymerization reactors (not shown), or to multiple entry ports (not shown) in a single polymerization reactor, in the direction of arrows 91 and 93, respectively. Reactor conduits 90, 92 include diameters created cross-sectional areas of reactor conduits 90, 92 that, when added together, are substantially identical to diameter 83, and thus, the cross-sectional area, of polymerization reactant mixture conduit 80 to further reduce the possibility of back-flow into catalyst conduit 70.

It is noted that conduit junction 84 may be disposed downstream from conduit junction 86. Moreover, conduit junction 86 may be in the shape of a cross having four connection points, or in another shape having more than four connection points. Therefore, one of the connection points may permit polymerization reactant mixture to be removed from polymerization reactant injection system 40 for sampling or other quality control tests, e.g., having sample port 96 (without the need for conduit junction 84), one connection point may be used for incoming polymerization reactant mixture, and the remaining two connection points may be used for outgoing polymerization reactant mixture to the polymerization reactor(s). Alternatively, additional reactor conduits may be connected to conduit junction 86, and conduit junction 86 may have more than four connection points, to facilitate transportation of the polymerization reactant mixture to additional polymerization reactors or multiple entry ports in one or more polymerization reactors. Conduit junction 86 may also be a valve having more than one port for splitting or diverting the flow of the polymerization reactant mixture to one or more polymerization reactors, e.g., for charging more than one polymerization reactors in sequence.

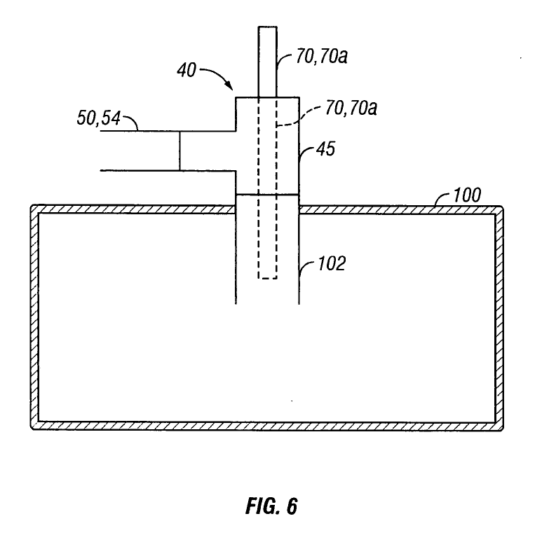

Referring now to FIG. 6 in another specific embodiment of the invention, polymerization reactant injection system 40 includes conduit junction 45, monomer conduit 50 (or monomer/co-catalyst conduit 54 as discussed in greater detail above, and catalyst conduit 70, 70a. Polymerization reactor 100 includes mating port 102 for securing conduit junction 45 to polymerization reactor 100. In this embodiment, polymerization reactant mixture may be formed within conduit junction 45 or, as shown in FIG. 6, within mating port 102, and deposited into polymerization reactor 100.

As mentioned above, it is to be understood that the size of the inner diameters, or diameters, of the various conduits making up polymerization reactant injection system 40 are dependent upon the type of catalyst, co-catalyst (if any), monomer, and the velocity of the polymerization reactant mixture from polymerization reactant injection system 40. In a preferred embodiment, titanium trichloride is the catalyst, alkylaluminoxane and ethylene dichloride are the co-catalysts, and 1-dodecene is the monomer. In this embodiment, monomer conduit 50 is under pressure in the range from 20 psi to 25 psi at conduit junction 45; the catalyst source tank is under pressure in the range from 5 psi to 15 psi; and the co-catalyst source tanks are under pressure in the range from 25 psi to 35 psi. The pressure in polymerization reactant mixture conduit 80 and reactor conduits 90, 92 are less than the pressure in catalyst conduit 70 to prevent back-flow. Unless otherwise noted, the foregoing pressure measurements were taken at the point where each polymerization reactant is released from its conduit to be combined with another polymerization reactant and where the polymerization reactant mixture is released into the polymerization reactor.

Also in this embodiment, monomer conduit 50 is circularly-shaped having a diameter in the range from 0.40 inches to 0.45 inches, e.g., 0.43 inches; co-catalyst conduit 60 is circularly-shaped having a diameter in the range from 0.15 inches to 0.20 inches, e.g., 0.18 inches; monomer/co-catalyst conduit 54 is circularly-shaped having a diameter in the range from 0.35 inches to 0.40 inches, e.g., 0.375 inches; catalyst conduit 70,70a is circularly-shaped having a diameter in the range from 0.1 inches to 0.15 inches, e.g., 0.125; catalyst conduit 70, 70b is circularly-shaped having diameter 73 in the range from 0.06 inches to 0.07 inches, e.g., 0.0625 inches; polymerization reactant mixture conduit 80 is circularly-shaped having diameter 83 in the range from 0.5 inches to 0.75 inches, e.g., 0.625 inches; and catalyst conduit 70, 70b is disposed within, concentric with, and extends approximately 4.5 inches into, polymerization reactant mixture conduit 80. In this embodiment, the velocity of the monomer, or the monomer/co-catalyst mixture, being transported into polymerization reactant mixture conduit 80 is in the range from 10 lbs/min to 30 lbs/min; the velocity of the catalyst being transported into polymerization reactant mixture conduit 80 is in the range from 0.10 lbs/min to 0.50 lbs/min; and the velocity of the polymerization reactant mixture from polymerization reactant injection system 40 is in the range from 10.10 lbs/min to 30.50 lbs/min. In an embodiment in which two reactor conduits 90, 92 are included, each reactor conduit 90, 92 is circularly-shaped having a diameter in the range from 0.40 inches to 0.45 inches, e.g., 0.43 inches. Therefore, the sum cross-sectional area of the two reactor conduits, 90,92 is 0.29 inches, i.e., reactor conduit 90 has a cross-sectional area of 0.145 inches and reactor conduit 92 has a cross-sectional area of 0.145 inches. The sum total of the cross sectional areas of reactor conduits 90, 92 is 0.017 inches less than the cross-sectional area of polymerization reactant mixture conduit 80 having diameter 83 of 0.625 inches, and thus, cross-sectional area of 0.307 inches.

In an embodiment in which sample port 96 is included, sample port 96 is circularly-shaped having a diameter in the range from 0.2 inches to 0.3 inches, e.g., 0.25 inches. In an embodiment in which catalyst bypass conduit 78 is included, catalyst bypass conduit 78 is circularly-shaped having a diameter in the range from 0.1 inches to 0.15 inches, e.g., 0.125.

In the event that the lengths of monomer conduit 50, co-catalyst conduit 60, catalyst conduit 70 and polymerization reactant mixture conduit 80 are increased, the diameters of these conduits may also be increased as desired or necessary to maintain the desired velocity differential, or pressure differential, to facilitate formation of the polymerization reactant mixture.

Polymerization reactant injection systems 40 of the present invention may be used to inject various types of polymerization reactant mixtures into various types of polymerization reactors. As mentioned above, numerous polymerization methods, reactants, i.e., monomers, catalysts, co-catalysts, are known to persons of ordinary skill in the art. Additionally, bulk polymerization methods, as well as other types of polymerization methods, are known to persons of ordinary skill in the art. However, none of these known polymerization methods and systems have included the polymerization reactant injection system 40 of the present invention.

In one specific embodiment of the present method of forming a polymerization reactant mixture, at least one catalyst at a first velocity is injected into at least one monomer at a second velocity, wherein the first Velocity is greater than the second velocity, thereby forming the polymerization reactant mixture. Preferably, at least one co-catalyst is combined with the at least one monomer to form a monomer/co-catalyst mixture prior to the injection of the at least one catalyst.

In another specific embodiment of the method of forming a polymerization reactant mixture, the at least one monomer at a first velocity is injected into the at least one catalyst at a second velocity, wherein the first velocity is greater than the second velocity, thereby forming the polymerization reactant mixture.

It is to be understood that the invention is not limited to the exact details of construction, operation, exact materials, or embodiments shown and described, as obvious modifications and equivalents will be apparent to one skilled in the art. For example, each of the monomer conduit, the co-catalyst conduit, and the catalyst conduit may have any diameter or length desired or necessary to facilitate combination of the polymerization reactants. Moreover, more than one catalyst conduit, co-catalyst conduit, and monomer conduit may be included in the polymerization reactant injection system to create a polymerization reactant mixture comprising more than one monomer, more than one catalyst, or more than one co-catalyst. Additionally, the velocity differential between the catalyst conduit and the polymerization reactant mixture conduit may be created using pumps (by increasing or decreasing the rate of flow through the catalyst conduit and the polymerization reactant mixture conduit, even though the diameters of the catalyst conduit and the polymerization reactant mixture may be the same), by differing diameters of conduits, by increasing, or decreasing, the pressure on the source tanks of the polymerization reactants, or by any other method known to persons of ordinary skill in the art. Further, pumps, vacuums, or other devices may be used to transport the polymerization reactants into, and through, the polymerization reactant injection systems. Accordingly, the invention is therefore to be limited only by the scope of the appended claims.

1. A polymerization reactant injection system comprising:
at least one monomer conduit for transporting at least one monomer at a first fluid parameter;
at least one catalyst conduit for transporting at least one catalyst at a second fluid parameter, the at least one catalyst conduit being in fluid communication with the at least one monomer conduit; and
at least one polymerization reactant mixture conduit, wherein the at least one monomer is combined with the at least one catalyst to form a polymerization reactant mixture within the at least one polymerization reactant mixture conduit;
wherein the first fluid parameter and the second fluid parameter create a fluid parameter differential.

2. The polymerization reactant injection system of claim 1, further comprising at least one co-catalyst conduit for transporting at least one co-catalyst, the at least one co-catalyst conduit being in fluid communication with the at least one monomer conduit,
wherein the at least one monomer is mixed with the at least one co-catalyst to form a monomer/co-catalyst mixture.

3. The polymerization reactant injection system of claim 2, wherein the at least one monomer conduit and the at least one co-catalyst conduit intersect each other at a first conduit junction, the first conduit junction being in fluid communication with the polymerization reactant mixture conduit.

4. The polymerization reactant injection system of claim 3, wherein a monomer/co-catalyst mixture conduit is in fluid communication with the first conduit junction and the polymerization reactant mixture conduit.

5. The polymerization reactant injection system of claim 4, wherein a second conduit junction is in fluid communication with the monomer/co-catalyst mixture conduit, the catalyst conduit, and the polymerization reactant mixture conduit.

6. The polymerization reactant injection system of claim 5, wherein the polymerization reactant mixture conduit includes a third conduit junction, whereby the polymerization reactant mixture is transported to at least one polymerization reactor through at least one reactor conduit, the at least one reactor conduit being in fluid communication with the third conduit junction.

7. The polymerization reactant injection system of claim 2, wherein a portion of the at least one catalyst conduit is disposed within the at least one monomer conduit.

8. The polymerization reactant injection system of claim 2, wherein a portion of the at least one monomer conduit is disposed within the at least one catalyst conduit.

9. The polymerization reactant injection system of claim 1, wherein the catalyst conduit has a first diameter and the polymerization reactant mixture conduit has a second diameter, the first diameter being smaller than the second diameter.

10. The polymerization reactant injection system of claim 9, wherein a portion of the catalyst conduit is disposed within the polymerization reactant mixture conduit.

11. The polymerization reactant injection system of claim 1, wherein the catalyst conduit has a first diameter and the polymerization reactant mixture conduit has a second diameter, the first diameter being larger than the second diameter.

12. The polymerization reactant injection system of claim 11, wherein a portion of the polymerization reactant mixture conduit is disposed within the catalyst conduit.

13. The polymerization reactant injection system of claim 1, wherein the first fluid parameter is a first pressure, the second fluid parameter is a second pressure, and the fluid parameter differential is a pressure differential.

14. The polymerization reactant injection system of claim 1, wherein the first fluid parameter is a first velocity, the second fluid parameter is a second velocity, and the fluid parameter differential is a velocity differential.

15. The polymerization reactant injection system of claim 1, wherein the polymerization reactant mixture conduit is formed by the at least one monomer conduit and a portion of the at least one catalyst conduit is disposed within the at least one monomer conduit.

16. The polymerization reactant injection system of claim 1, wherein the polymerization reactant mixture conduit is formed by the at least one monomer conduit and a portion of the at least one monomer conduit is disposed within the at least one catalyst conduit.

17. A polymerization reactant injection system comprising:
a monomer conduit for transporting at least one monomer at a first fluid parameter in fluid communication with a catalyst conduit for transporting at least one catalyst at a second fluid parameter,
wherein the at least one catalyst is combined with the at least one monomer to form a polymerization reactant mixture, and
wherein the first fluid parameter and the second fluid parameter form a fluid parameter differential.

18. The polymerization reactant injection system of claim 17 wherein the first fluid parameter is greater than the second fluid parameter.

19. The polymerization reactant injection system of claim 18 wherein the first fluid parameter is a first pressure, the second fluid parameter is a second pressure, and the fluid parameter differential is a pressure differential.

20. The polymerization reactant injection system of claim 18 wherein the first fluid parameter is a first velocity, the second fluid parameter is a second velocity, and the fluid parameter differential is a velocity differential.

21. The polymerization reactant injection system of claim 17 wherein the first fluid parameter is less than the second fluid parameter.

22. The polymerization reactant injection system of claim 21, wherein the first fluid parameter is a first pressure, the second fluid parameter is a second pressure, and the fluid parameter differential is a pressure differential.

23. The polymerization reactant injection system of claim 21, wherein the first fluid parameter is a first velocity, the second fluid parameter is a second velocity, and the fluid parameter differential is a velocity differential.

24-31. (canceled)
